(19) United States
(12) Patent Application Publication
(10) Pub. No.: US 2017/0191444 A1
(43) Pub. Date: Jul. 6, 2017

(54) HOOD MODULE AND METHOD FOR PRODUCING A HOOD MODULE

(71) Applicant: THYSSENKRUPP PRESTA TECCENTER, Eschen (LI)

(72) Inventors: Jürgen MEUSEL, Dittmannsdorf (DE); Walter SCHIMMER, Munich (DE)

(73) Assignee: ThyssenKrupp Presta TecCenter AG, Eschen (LI)

(21) Appl. No.: 15/308,744

(22) PCT Filed: Apr. 10, 2015
(86) PCT No.: PCT/EP2015/057867

§ 371 Date: Nov. 3, 2016

(30) Foreign Application Priority Data
May 9, 2014 (DE) 10 2014 106 561.1

(51) Int. Cl. F02F 7/00; F02F 1/24; F01L 1/047; F02F 11/00

(52) U.S. Cl. CPC F02F 7/006; F02F 11/002; F02F 1/24; F01L 1/047; F02F 2007/0063; F02F 2200/06; F01L 2001/0476

(57) ABSTRACT

A hood module for attachment on a cylinder head of an internal combustion engine may include a hood body comprised of plastic and a bearing bracket comprised of metal as a rotatable holder for a camshaft in the hood module. The bearing bracket may be attached to the hood body with position accuracy by a joint connection so that the bearing bracket is aligned for attachment on the cylinder head through the hood body. In some examples, a joint element in the form of a sleeve may be used as part of the joint connection between the bearing bracket and the hood body.”

The present invention concerns a hood module (cover module) for attachment on the cylinder head of an internal combustion engine with a hood body made of plastic and with at least one bearing bracket including metal material for holding at least one camshaft in the hood module in a rotatable manner.

### PRIOR ART

Hood modules can also be described as cylinder head cover or camshaft modules and be used to hold mostly one or two camshafts that can work together with valves in the internal combustion engine by means of cam followers or rocker arms when the hood module is disposed on the cylinder head of the internal combustion machine. Through this method, hood modules are constructed to be as lightweight as possible, soundproof and be able to be easily assembled. For this purpose, it is already known that the hood module is to be developed in plastic, and the at least one bearing bracket includes metal material because said bracket holds the camshaft and is subject to greater mechanical loads.

The plastic of the hood body makes advantageous insulation characteristics possible in the hood module and in doing so, the metal material of the bearing bracket meets the fastening requirements in order to hold the camshaft in the hood module. Aside from a simple design, simple production, good insulation characteristics and a low weight, the hood modules should nonetheless be easily manageable, in particular during production and assembly, and in the best case, a hood module should be able to be delivered to a manufacturer, who can attach the hood module to the cylinder head of an internal combustion engine in a simple way without major adjustment and positioning procedures. Moreover, the production of the hood module should also, however, be developed as easily as possible itself.

DE 196 03 692 A1 reveals a cylinder head cover with a storage aisle carrier for the camshaft bearings where the storage aisle carrier extends under the entire hood body, which is produced in plastic, so that the cylinder head cover has a relatively high mass.

DE 100 34 329 C2 shows a valve hood for internal combustion engines and the bracket bearings shown are insert-molded through a hood body made of plastic, basically completely with the plastic material. The bracket bearings can in this way by precisely aligned so that the valve hood can easily be disposed ready-made on a cylinder head of an internal combustion engine, but the insert-molding of the bearing blocks requires a high mass fraction in plastic. The bearing blocks must additionally be connected with each other by a supporting structure that is formed from a metal material and so increases the weight of the valve hood.

Finally, DE 10 2008 007 091 A1 shows a pre-assembled camshaft module to attach to the cylinder head of an internal combustion engine, and bearing brackets made of a metal material are provided that can be pre-fused on a hood body made out of plastic. Screws, with which the bearing brackets are held on the cylinder head up till assembly, essentially free-moving, are provided here. First, in assembling the camshaft module, the bearing brackets are aligned to each other and fastened to the valves or the tapping elements of the valve on the cylinder head, and only subsequently can the screws that are inserted in the hood body be suitably tightened. Disadvantages that are to be avoided consequently arise in handling when the camshaft module is assembled. In the process, additional machining operations and positioning procedures are to be avoided in particular because these procedures must be dealt with at the client's, where optimal camshaft module mountability does not exist.

In particular, for mass-production capable manufacturing of cylinder head covers in hybrid construction, thermoplastic hoods/covers have to be connected with bearing brackets in short cycle times. The plastic hood itself advantageously uses the hermetic sealing of the valve drive and should consequently be fluid-impermeable—in particular oil-impermeable—on the surface. To do this, the joint locations in the materials must be realized without outward perforation, i.e. to the outer environment.

### DISCLOSURE OF THE INVENTION

The object of the present invention is the preparation of a hood module (cover module) for attachment on a cylinder head of an internal combustion engine, where the hood module presents a low weight and should be easy and cost-efficient to assemble and where the hood module should also have good acoustic insulation and a simple design.

Said object is solved based on a hood module for attachment on a cylinder head of an internal combustion engine according to the generic term of Claim 1 and based on a procedure to form a hood module according to the known characteristics of Claim 11 with the respective characteristic features. Advantageous further features of the invention are stated in the dependent claims.

The invention includes the technical knowledge that the bearing bracket is disposed on the hood body with position accuracy by a joint connection, so that the bearing bracket is aligned for attachment on the cylinder head through the hood body.

The design of a hood module according to the invention allows simple handling of the hood module when operating with minimal weight, which can be fitted as a unit on the cylinder head of an internal combustion engine and fastened to said cylinder head without the bearing bracket or preferably several bearing brackets having to be attached to the cylinder head or aligned relative to each other and individually fastened, for example, bolted. According to the invention, the hood body is used to form a protective hood for sound insulation on the basis of plastic material and in particular as a carrier for one or more bearing brackets. According to the invention, the bearing brackets are at the same time to be provided without injecting a large mass of plastic, fastened relative to each other, and there merely remains the necessity of fastening the whole hood module to the cylinder head by simple means where as a result one or more bearing brackets is fastened relative to the cylinder head.

By a position-specific arrangement, an arrangement in particular is to be understood in which the planar orientation of the hood module on a cylinder head can be produced so that the arrangement of the hood module on the cylinder head can be screwed on ready for subsequent operation.

According to a particular advantage of the design of the joint connection according to the invention, this can contain at least two joint locations between the bearing bracket and the hood body. As a rule, a hood module has several bearing brackets for the rotatable holder of a camshaft, and each bearing bracket can contain two joint locations with which the joint connection is formed between the respective bearing bracket and the hood body. For production of the hood module, the bearing brackets can, for example, be fastened in a holding device so that the bearing brackets already have the location to each other that is required for holding the camshaft later. By way of example, the camshaft can be pre-fused in the bearing brackets so that the bearing brackets already have their ultimately required position relative to each other. Finally, a defined position arrangement of the bearing brackets relative to the means of fastening the hood module to the cylinder head is still required in the assembly tool. The plastic hood body made in the injection mold can be brought into connection with the bearing brackets after fixation of said bearing brackets without them having to be insert-molded even only partially with the plastic mass of the hood body. The hood body can consequently be injected from a minimal plastic mass; moreover the bearing brackets must not present any corresponding geometry in order to make form-locking injection of the bearing brackets possible.

In the framework of the present invention, plastic describes every material of low density that is at least lower than in a metal material used to form the hood body. Through this method, the plastic can have non-synthetic components as well, for example by fiber reinforcing. Laminated, fibrous materials or fiber glass or carbon fiber materials are also included under the concept of plastic.

Due to the design of the hood module according to the invention, a necessary support structure is also avoided because the hood body itself already provides this support between the bearing brackets. The hood module can therefore only be designed weight-minimally where said module is designed to be attached to the cylinder head with fastenings so that the bearing brackets are disposed in the force flow of said fastening between the hood module and the cylinder head.

According to an advantageous further feature of the invention, the joint connection and in particular the joint locations can be formed by at least one joint element. The joint element can in this way be designed in the form of a sleeve and be glued into or pressed into the bearing bracket and/or the hood body. The joint element can form the joint location between the bearing bracket and the hood body so that for every bearing bracket, for example, two joint elements are planned in two joint locations spaced apart from each other for attachment on the hood body.

The joint elements can be fitted to the plastic material of the hood body according to a further advantageous embodiment to form a melting zone. In this way, the joint elements are first disposed on the bearing brackets or the joint elements are formed on the bearing bracket and can in particular be heated together with an adjoining area of the bearing bracket. In this way, the joint elements can be brought to a temperature that ensures that the plastic material of the hood body will melt.

If the bearing bracket is imprinted with the joint elements in the plastic of the hood body or if the hood body is applied on the joint element in the bearing bracket by means of a stamp, there is local melting of the joint area on the hood body, and after the joint location cools down, a firmly bonded load-bearing or even a form-locking connection is made between the bearing bracket and the hood body by the joint element that is penetrated over a partial length in the plastic of the hood body.

Due to this connection technique, there are particular advantages in producing the hood module, because after simple heating, the joint element and the area of the bearing bracket of the hood bodies must only be put on one or more bearing brackets in order to produce the connection of the hood body to the bearing bracket(s) when the melting zone is formed. Alternatively, an auxiliary element can also be designed that is put on an end of the joint element, for example, pressed on or screwed on, by which a form-locking connection of the bearing bracket can also be created with the hood body by a joint element.

In the design of the hood module according to the invention, it depends in particular on the hood module, exactly positioned as a whole, being disposed on the cylinder body of the internal combustion engine. At least two mounting holes can be designed in the hood body and/or in the bearing bracket, in which fasteners can be accommodated and with which the hood module can be fastened to the cylinder head. The mounting holes can here extend through the hood body; the invention however preferably envisages that the mounting holes extend at least partially through the bearing brackets. The mounting holes can be dimensioned so that connecting elements that have been fed through have some clearance through them. One orientation of the hood module on the cylinder head is, for example, over two fastening locations that can be found in the bearing brackets, or the fastening locations are accommodated on the hood body or formed in it. If the hood module has been put on a cylinder head of an internal combustion engine and has been aligned over the (at least) two fastening locations, connecting elements can be fed through the mounting holes and the hood module can be screwed tightly on to the cylinder head over the bearing brackets. This screw connection is particularly simple because the connecting elements, for example, designed as screws, can be inserted and tightened in the mounting holes from the top side.

The joint elements designed in the form of a sleeve can align with the mounting holes. In particular, the joint elements in the form of a sleeve can at any one time form a part of the mounting holes. If the connecting elements are fed through the mounting holes and consequently through the joint elements in the form of a sleeve as well, there is additional protection of the connection between the hood body and the (at least one) bearing bracket. When the internal combustion engine operates later, it can be ensured in this way that the bearing brackets cannot be dismantled from the hood body.

Alternatively, the design according to the invention can have the joint elements in the shape of a pin or a feather and, for example, inserted next to the mounting holes between the bearing brackets and the hood body. These can heat up in the same way as the joint element in the form of a sleeve and be melted into the plastic of the hood body. Here, two joint elements can also be designed and for example, an adjacent joint element can be attached to each mounting hole used to pass a connecting element, for example a screw, through it.

The bearing bracket can be developed for holding one or two camshafts and in particular, the bearing bracket can have at least one bearing ring that is inserted in a fitting aperture in the bearing bracket and be used for holding the camshaft in a rotatable manner. The bearing bracket can here be produced in a metallic material, for example, aluminum, and in doing so, the bearing bracket does not have to be completely made of metal. The bearing bracket can for example have a plastic part and in this case, the metal covering for the bearing bracket can be bounded by at least one bearing ring, for example. If two camshafts are accommodated in the hood module, the bearing bracket can have two mounting apertures and a bearing ring can be introduced into each mounting aperture, for example pressed in.

The present invention is also based on a procedure to form a hood module that is designed to be attached onto a cylinder head of an internal combustion engine with a hood body made of plastic and with at least one bearing bracket including a metal material for rotary holding of at least one camshaft in the hood module, where the procedure includes at least the step of providing the hood body and at least one bearing bracket; moreover the procedure includes the alignment of the bearing bracket on the hood body and/or the alignment of several bearing brackets with each other, joining the bearing brackets to the hood body is provided for by a joint connection, in which the bearing bracket is disposed with the joint connection so that the bearing bracket is aligned for attachment to the cylinder head.

Thereby, the procedure can include providing at least one joint element that is disposed on the bearing bracket and the hood body to form the joint connection. In particular, at least two joint elements with a space between them can be designed to connect a bearing bracket to the hood body in order to form two joint locations between the bearing bracket and the hood body.

The joint locations and in particular the joint element can be heated more advantageously so that the joint element is brought into contact with said joint element to form a melting zone in the plastic material of the hood body or in an auxiliary element, and is fitted to this. In forming a melting zone, the following advantage is achieved: the bearing brackets can be pre-fused before the hood body is put on the bearing bracket, and putting the hood body on the bearing bracket occurs through a one-dimensional and essentially forceless joining movement, and the hood body is held by handling over the bearing bracket until the melting area has solidified around the joint element.

In the design of the hood module according to the invention, the precisely positioned arrangement of the hood body for the bearing bracket is not the focus of attention as long as the hood module is connected to the cylinder head over the bearing bracket(s) that are held by the hood body. Therefore, the advantage arises that an analogously precise attachment of the bearing brackets to the hood body is not necessary, through which the production of the hood module and the handling of the individual components in production is clearly simplified. At the focus of attention is the attachment of several bearing brackets relative to each other with a corresponding precision, which is maintained by the hood body that is used as a fastening and holding body for bearing brackets. If the hood module is provided with the bearing brackets aligned with each other on the cylinder head of an internal combustion engine, the bearing brackets can be mounted on the cylinder head with connection elements in which mounting holes are planned in the hood module that pass through the bearing bracket with particular advantage. Therefore, the bearing brackets can be solidly disposed on the cylinder head, where the hood body merely takes over the fixation of the bearing brackets to each other and relative to the cylinder head, in which the valve and/or tapping elements are held that are driven by the camshaft and that can be inserted in the hood module.

To orient the hood module, two positioning elements that correspond to each other, such as sleeves that fit in an opening, pin or nut feathering elements, can be formed especially on the bearing bracket and the cylinder head. By means of the positioning elements the hood module is then oriented on the cylinder head over said cylinder head before it is fastened to it.

Additionally, the invention-improving measures are presented in more detail below through the figures, together with the description of a preferred exemplary embodiment of the invention. The schematic diagrams show the following:

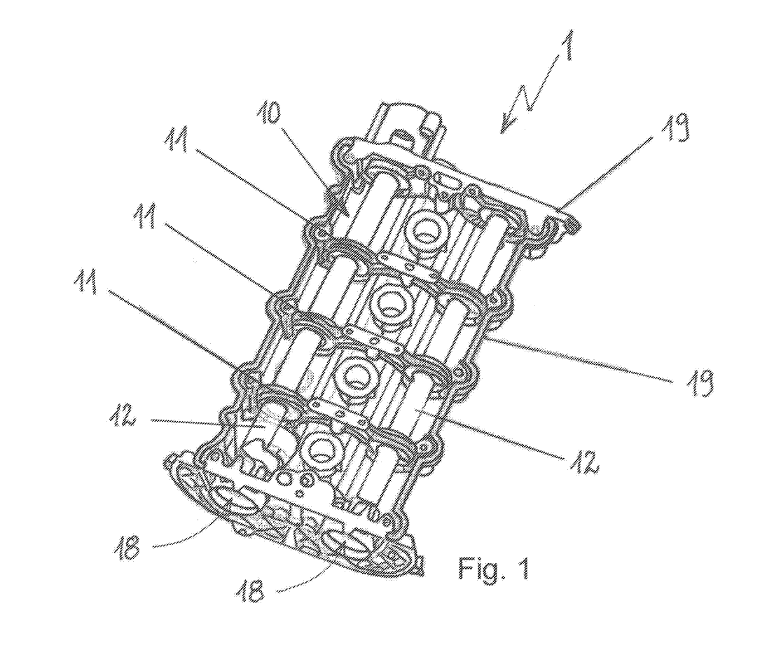

FIG. 1 a perspective bottom view of a hood module with a hood body and three bearing brackets that are disposed on the hood body,

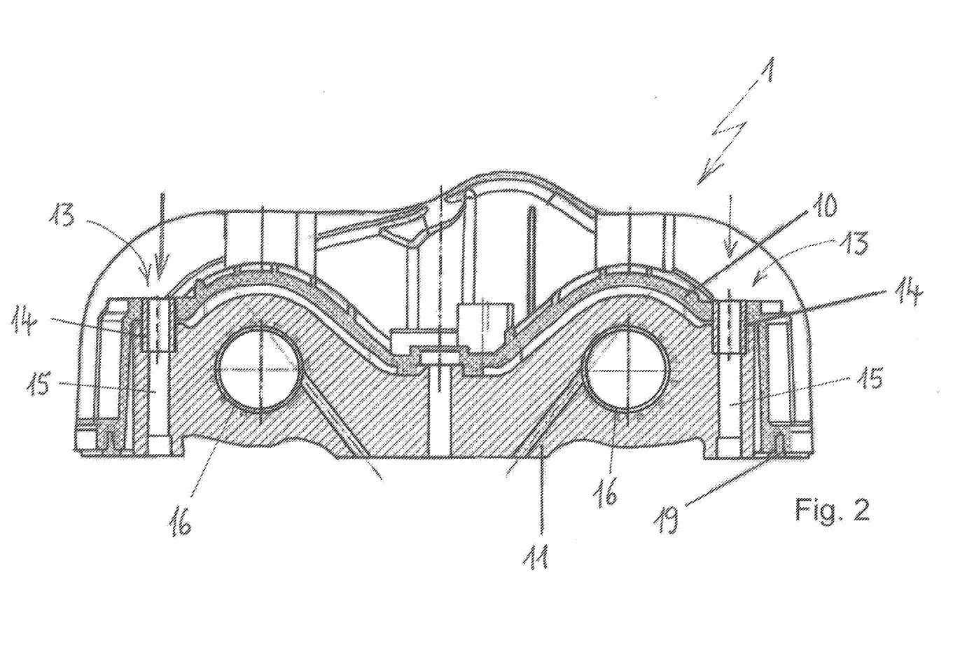

FIG. 2 a cross-sectional view through the hood module according to FIG. 1 in the area of a bearing bracket,

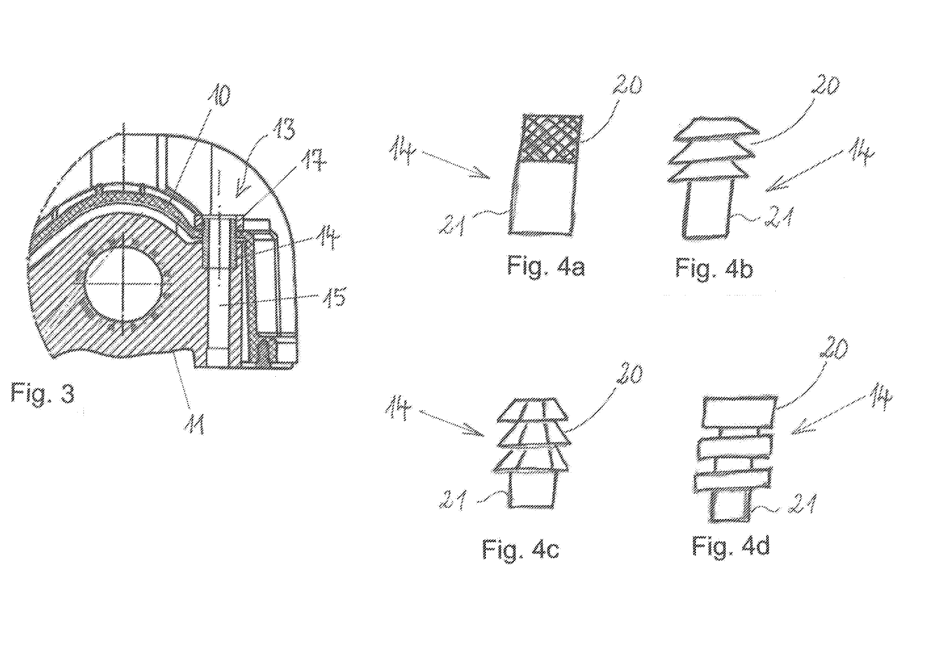

FIG. 3 a particular design of a joint location between the bearing bracket and the hood body in a detailed view,

FIGS. 4a-4d different designs of a joint element to be connected to a hood body, and

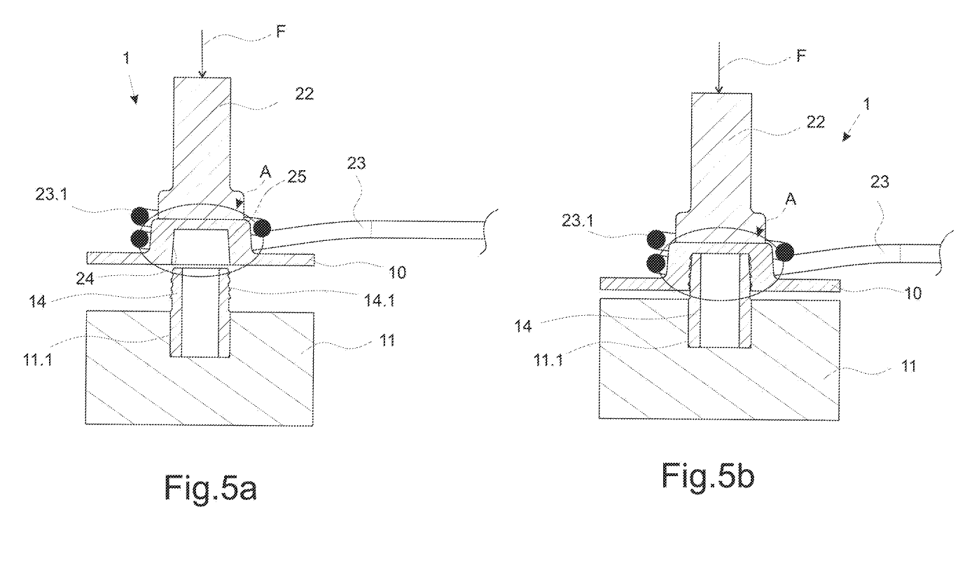

FIGS. 5a-5b Cross-sectional representations of a detail of one embodiment of a hood module during the assembly process of a hood body to the bearing bracket.

FIG. 1 shows a hood module 1 in a perspective view from the bottom side, and hood module 1 has a hood body 10 that has a cover-like or hood-like shape and forms the basic structure of hood module 1. Hood body 10 is produced in plastic material in an injection molding process. The hood body can, for example, be produced in fiber-reinforced polyamide.

In the inner area of hood body 10, there are three visible bearing brackets 11 for rotatable holding of two camshafts 12 running parallel to each other. The side walls of hood body 10 include further bearing brackets in a not presented or only partially presented way so that camshafts 12 are held in a total of five bearing brackets on hood module 1. Camshafts 12 can be inserted through insertion apertures 18 on the side of hood body 10 that can at the same time be the first bearing position of camshaft 12, at which camshafts 12 are shown in simplified form without lifter elements.

Hood module 1 can be disposed on a cylinder head of an internal combustion engine and in order to achieve a sealed attachment of hood module 1 on the cylinder head, hood body 10 has seals 19, through which the camshaft space inside hood body 10 can be sealed and locked.

Bearing brackets 11 shown here are connected with hood body 10 over joint locations as is presented in more detail in the cross-section view of hood module 1 in FIG. 2 below.

FIG. 2 shows a transverse view through hood module 1 in the area of a bearing bracket 11, so that hood body 10 and bearing bracket 11 are displayed in a cross-section view. Bearing bracket 11 is fastened on hood body 10 with two joint connections 13. Joint elements 14 that are designed in the form of a sleeve and are produced in a metallic material for example are provided to form joint connections 13. There are located mounting holes 15 in bearing brackets 11, and joint elements 14 in the shape of a sleeve align with mounting holes 15 and form part of them. If bolt elements are inserted in joint elements 14 and mounting holes 15 after that in the arrow direction shown, hood module 1 can be fastened on the cylinder head of the internal combustion engine in which the bolt elements are screwed on in the threaded hole provided in the cylinder head. The bolt elements can here have a cylinder pin section for centering so that a precisely positioned arrangement of hood module 1 is possible on the cylinder head. By feeding through mounting holes 15 in bearing brackets 11, the bolt elements provide for a mechanical load of the connection being able to occur between bearing brackets 11 and the cylinder head without the load having to be directed over hood body 10 which is made of plastic.

Joint elements 14 are partially inserted in bearing bracket 11 and partially in hood body 10. For example, joint element 14 can be pressed into the upper section of mounting hole 15, and joint element 14 can be inserted where a melting area is formed in a prepared through bore in hood body 10. When producing joint element 13, bearing bracket 11 is pre-fused in a joint tool, and when hood body 10 is put in production of joint connection 13, the exact position of bearing bracket 11 is properly frozen for later attachment on the cylinder head by hood body 10. Consequently, hood body 10 is used for both as a hood element protecting against contamination and humidity, as a sound insulation element, and also as a holding or fastening element for bearing brackets 11 for later attachment on the cylinder head of the internal combustion engine.

FIG. 3 shows an alternative design of joint connection 13 between bearing bracket 11 and hood body 10 as a variation to the exemplary embodiment in FIG. 2. Joint connection 13 includes a joint element 14 that is pressed into bearing bracket 11 for example and is aligned with mounting hole 15. Joint element 14 projects over hood body 10 and is made secure with an auxiliary element 17. Auxiliary element 17 can for example be screwed on or pressed on to the upper section of joint element 14. In particular, the auxiliary element can have plastic material that as just like hood body 10 can be melted with a heated joint element and then the plastic in auxiliary element 17 can solidify in a fixed arrangement on joint element 14.

As a variant of the exemplary embodiment from FIG. 3a, it can alternatively be planned that the joint elements are penciled in or feathered in and are, for example, inserted next to the mounting hole between the bearing brackets and the hood body. These can heat up in the same way as the joint element in the form of a sleeve and be melted into the plastic of the hood body. Here, two joint elements can also be designed and for example, an adjacent joint element can be attached to each mounting hole used to pass a connecting element, for example a screw, through it. Alternatively, the joint element does not have to be disposed in the area of the mounting hole.

Generally, the joint element can be inserted before a casting process for the bearing brackets as an insert component in a tool. Subsequently, in metal pressure casting for example, aluminum or a similar material can then be poured in. In this way, a connection between the joint element and the bearing pressures can be created simply.

Finally, FIGS. 4a, 4b, 4c and 4d show different designs for joint element 14 respectively with an insertion area 21 for attachment in the upper area of mounting aperture 15 in bearing bracket 11, and joint element 14 has differently designed joint element 20, with which joint elements 14 can be inserted in the plastic material of hood body 10, and can in particular be melted into it.

FIG. 4a shows a joint element 14 with a joint area 20 that has knurling, and the knurling can for example, besides an adhesive bond or a form closure, include cross grooves in order to create a form-locking part with the plastic material when it melts into the plastic material of hood body 10.

FIG. 4b shows a design of a joint element 14 with a joint area 20 that is designed in the shape of a fir tree with conical sides.

FIG. 4c shows a fir tree-shaped joint area 20 of joint element 14 with interrupted conical sides.

Finally, FIG. 4d shows a joint element 14 with a joint area 20 that includes cylindrical sides.

The different forms of joint area 20 of joint element 14 for melting into the plastic material of hood body 10 allows a form-locking connection of joint element 14 with hood body 10, in particular when plastic material that is melted by heating joint element 14 and is in this way ready to turn liquid, can be moved into the fluting of the knurling according to FIG. 4a or into the indentation according to FIGS. 4b, 4c and 4d. Therefore, a resilient connection forms between bearing bracket 11 and hood body 10 in order to guarantee a loss-secure attachment of bearing brackets 11 on hood body 10.

In FIG. 5a, an initial process step in particular for joints or applying a hood body 10 on a bearing bracket 11 is shown to form a hood module 1. Here an inductor that can be displaced in joint direction F acts for example, which is designed in the form of an induction coil 23 with which the plastic part to be joined, namely hood body 10 together with a tool 22 such as a stamp for example. Tool 22 is, for example, used to hold and transport hood body 10 and to find or exercise a corresponding force in order to facilitate a joint of hood body 10 with bearing bracket 11, in particular joint element 14. Induction coil 23 advantageously has one or more 23.1 wraps that surround at least one joint section A of hood body 10. Joint section A advantageously has a recess 24 in which joint element 14 can be held at least in sections. Recess 24 extends advantageously to a material thickening 25, which is formed in the cladding of hood body 10 and extends advantageously from a surface of the cladding of hood body 10.

As shown in FIGS. 5a and 5b, it is conceivable that joint element 14 is developed in the form of a sleeve, a pin, a rod or a pipe. Joint element 14 advantageously has a surface structure 14.1. This surface structure 14.1 is advantageously formed on the outer surface of joint element 14. It is conceivable that the surface structure has for example a groove structure, a toothed structure or comparable material recesses or even material mouths. Surface structure 14.1 is advantageously used to allow at least one form-locking connection between joint element 14 and hood body 10.

Joint element 14 is advantageously connected to the bearing bracket 11 in a force-fittings manner (frictional connection). It is, however, also conceivable for the joint element to be alternatively or additionally connected by form-locking and/or positive substance jointing using bearing bracket 11. Joint element 14 extends advantageously at least partially, advantageously completely within a recess 11.1 in bearing bracket 11.

When bearing bracket 11 is connected with hood body 10, hood body 10 is applied on joint element 14 so that this permeates in opening 24 and this is advantageously completely filled in by joint element 14. A surface of hood body 10, adjusted for bearing bracket 11, advantageously connects here, a surface of bearing bracket 11, adjusted for hood body 10. Due to the electrical current flowing through induction coil 23, the material of joint element 14 is heated, by which the material of hood body 10 in contact with joint element 14 is also heated so that it ends in a deviation at least in sections in the area adjacent to joint element 14. The now moldable material of hood body 10 surrounds surface structure 14.1 of joint element 14 advantageously so that both components produce a form-locking connection with each other at least in sections. Therefore, an advantageous permanent connection between hood body 10 and bearing bracket 11 is made possible.

The invention is not limited in its embodiment to the existing indicated favored exemplary embodiment. A number of variants that are used in fundamentally different embodiments of the solution presented is in reality conceivable. All characteristics and/or benefits arising from the claims, the description or the drawings, including constructive units, spatial arrangements, can be essential to the invention both for themselves and also in the different combinations.

### LIST OF REFERENCE DRAWINGS

1 Hood module

10 Hood body

11 Bearing bracket

11.1 Recess

12 Camshaft

13 Joint connection

14 Joint element

14.1 Surface structure of the joint element

15 Mounting hole

16 Bearing ring

17 Auxiliary element

18 Insertion opening

19 Gasket

20 Joining area

21 Insertion area

22 Tool

23 Induction coil

23.1 Induction coil wrap

24 Opening

25 Material thickening

A Joint section of the hood body

F Joint direction

1.-13. (canceled)

14. A hood module for attachment on a cylinder head of an internal combustion engine, the hood module comprising:
a hood body comprised of plastic; and
a bearing bracket comprised of metal for holding a camshaft in a rotatable manner, wherein the bearing bracket is connected to the hood body by a joint connection so that the bearing bracket is aligned by the hood body for attachment on the cylinder head of the internal combustion engine.

15. The hood module of claim 14 wherein the bearing bracket is connected to the hood body with position accuracy by the joint connection.

16. The hood module of claim 14 wherein the joint connection between the bearing bracket and the hood body comprises at least two joint locations.

17. The hood module of claim 14 wherein the joint connection is formed by at least one joint element.

18. The hood module of claim 17 wherein the at least one joint element comprises a sleeve that is glued into or pressed into at least one of the bearing bracket or the hood body.

19. The hood module of claim 17 wherein the at least one joint element is configured to form a melting zone in the plastic of the hood body or in an auxiliary element.

20. The hood module of claim 14 further comprising at least two mounting holes disposed in at least one of the hood body or the bearing bracket, wherein each of the at least two mounting holes is configured to receive a fastener for fastening the hood module to the cylinder head.

21. The hood module of claim 14 wherein the joint connection is formed by a joint element that comprises a sleeve, the hood module further comprising at least two mounting holes disposed in at least one of the hood body or the bearing bracket, wherein each of the at least two mounting holes is configured to receive a fastener for fastening the hood module to the cylinder head, wherein the joint element is aligned with one of the at least two mounting holes.

22. The hood module of claim 21 wherein the sleeve forms a part of one of the at least two mounting holes.

23. The hood module of claim 14 wherein the joint connection is formed by at least one joint element, wherein the at least one joint element and the bearing bracket comprise a single piece.

24. The hood module of claim 14 wherein the joint connection is formed by at least one joint element, wherein the at least one joint element is formed in one piece with the bearing bracket and with the hood module in a casting process.

25. The hood module of claim 14 wherein the bearing bracket is configured to hold the camshaft, wherein the bearing bracket includes a bearing ring that is inserted in a fitting aperture in the bearing bracket and is used as a rotatable holder for the camshaft.

26. A method of forming a hood module for attachment on a cylinder head of an internal combustion engine, the method comprising:
providing a hood body comprised of plastic and a bearing bracket comprised of metal for holding a camshaft in a rotatable manner;
aligning the bearing bracket on the hood body;
joining the bearing bracket to the hood body using a joint connection so that the bearing bracket is aligned for arrangement on the cylinder head of the internal combustion engine.

27. The method of claim 26 wherein the bearing bracket is joined to the hood body with position accuracy so that the bearing bracket is aligned for arrangement on the cylinder head of the internal combustion engine.

28. The method of claim 26 further comprising:
providing a plurality of bearing brackets;
aligning the plurality of bearing brackets with one another and on the hood body; and
joining the plurality of bearing brackets to the hood body using joint connections.

29. The method of claim 26 further comprising providing a joint element for formation of the joint connection between the bearing bracket and the hood body.

30. The method of claim 29 further comprising:
heating the joint element;
heating a region near the joint connection so as to form a melting zone in the plastic of the hood body or in an auxiliary element; and
fitting the joint element to the melting zone in the hood body or the auxiliary element.

31. The method of claim 29 wherein a joint location and the joint element are heated so that the joint element is brought into contact with the joint location to form a melting zone in the plastic material of the hood body or in an auxiliary element, wherein the joint element is fitted in or to the melting zone.
